(19) United States
(12) Patent Application Publication
(10) Pub. No.: US 2012/0227653 A1
(43) Pub. Date: Sep. 13, 2012

(54) Rotationally Molded Article Having Compressible Truss

(76) Inventor: Stanley W. Widmer, Staples, MN (US)

(21) Appl. No.: 13/418,065

(22) Filed: Mar. 12, 2012

Related U.S. Application Data
(60) Provisional application No. 61/451,228, filed on Mar. 10, 2011.

(51) Int. Cl. B63B 5/00; B29C 67/00; B23P 11/00

(52) U.S. Cl. 114/85; 29/428; 29/527.1

(57) ABSTRACT

A rotationally molded article, preferably a boat or equivalent floatable marine structure, has a compressible truss structure either assembled to the mold and molded into the internal structure of the article, or added to a previously molded article and permanently attached in place. The compressibility of the truss accommodates key challenges to molding articles of large dimension without encountering buckling or twisting or other structural defects. For example, when molded integrally with the article, the compressible truss compresses as the thermoplastic material shrinks slightly during cooling. When added to a previously molded article, the compressible truss allows the article to withstand extreme amounts of applied force during use, e.g., encountering high waves in boats of seven meters [23 feet] or greater at speeds of at least 20 knots [37 km/h (or 10.3 m/s)].

### CROSS-REFERENCE

This application claims the benefit of provisional application number 61/451,228 filed Mar. 10, 2011.

### TECHNICAL FIELD

This application concerns methods for rotationally molding articles to impart exceptional strength and resistance to buckling or twisting, particularly in very large dimensions (e.g., seven meters [23 feet] or greater).

### BACKGROUND

Articles formed by rotational molding are disclosed and claimed in U.S. Pat. No. 6,460,478 (Widmer), the entire contents of which is incorporated by reference. A preferred, but not required, type of article is a boat or equivalent floatable marine structure (e.g., a dock). For example, the boat may comprise parallel hull walls interconnected by rows of spaced apart, molded V-shaped connectors. The connectors are formed in the rotational molding process. One of the mold sections has a mold surface for forming one of the hull walls, said surface having one or more rows of V-shaped indentations projecting toward an opposite mold surface. The V-shaped indentations have apexes that are spaced apart from the opposite mold surface by a distance that, during the molding process, will fill with molten material to form a molded connection between the finished hull walls. A dock is formed in an essentially similarly manner.

### SUMMARY

This application describes improved rotationally molded products and methods of making the same. The products are preferably boats and other water-borne structures such as decks, but those are only examples. In general, the rotationally molded article has a compressible truss structure either assembled to the mold and molded into the internal structure of the article, or added to a previously molded article and permanently attached in place. The truss comprises two halves which are designed to move relative to each other such that the truss as a whole may be compressed (i.e., reduced in size) when the article undergoes internal or external forces.

The compressibility of the truss accommodates key challenges to molding articles of large dimension without encountering buckling or twisting or other structural defects. For example, when molded integrally with the article, the compressible truss compresses as the thermoplastic material shrinks slightly during cooling. When added to a previously molded article, the compressible truss allows the article to withstand extreme amounts of applied force during use, e.g., encountering high waves in boats of seven meters [23 feet] or greater at speeds of at least 20 knots [37 km/h (or 10.3 m/s)].

### BRIEF DESCRIPTION OF THE DRAWINGS

The accompanying drawings show particular embodiments as examples only, and are not intended to limit the scope of the claims.

FIGS. 1-10 illustrate a scale model of two embodiments.

FIG. 1 is a side view. The “molded-in” embodiment in the upper portion of the Figure is designed to be incorporated into a molded article during the molding process. The “added-to” embodiment in the lower portion of the Figure is designed to be added to previously molded articles.

FIGS. 2 and 3 are side views of two truss members forming the “molded-in” embodiment of FIG. 1.

FIG. 4 is an enlarged side view of the portions of FIGS. 2 and 3 arranged adjacent to each other.

FIG. 5 is an end view of the truss portion of FIG. 2.

FIG. 6 is an enlarged side view of portions of the “added-in” embodiment adjacent to each other.

FIGS. 7 and 8 are respective upper and lower views of a truss member of the embodiment of FIG. 6.

FIG. 9 is an end view of the truss portion of FIG. 6.

FIG. 10 is an enlarged side view of the portions of FIG. 6 connected to each other.

FIGS. 11 and 12 are respective left and right portions of a single top view of a third embodiment, specifically a portion of a dock or similar platform.

FIGS. 13, 14, and 15 are respective left, center, and right portions of a single illustration of two alternative views of the third embodiment of FIGS. 11 and 12, one above the other. The upper view is a cross-sectional view denoted section F-F in FIGS. 11 and 12; the lower view is a side view.

FIGS. 16 and 17 show additional details from the third embodiment. FIG. 16 is a pair of side views beside each other. The view on the left is an end view. The view on the right is the cross-sectional view denoted E-E in FIGS. 11 and 12. FIG. 17 is the detail view denoted H in FIG. 14 (upper portion).

FIGS. 18-20 illustrate a boat incorporating a truss system according to the first embodiment. FIG. 18 is a cross-sectioned perspective view. FIG. 19 is an enlarged portion of FIG. 18. FIG. 20 is a non-cross-sectioned perspective view similar to FIG. 19 but omitting the molded boat hull for clarity only. In FIGS. 18 and 19, because the cross-sectional plane is essentially at the amidships plane (i.e., the mid-plane of the boat separating port from starboard), the truss components are shown in cross-section for clarity only.

FIG. 21 is a cross-sectioned perspective view of a boat incorporating a truss system according to the second embodiment. FIG. 22 is a plan view of the boat of FIG. 21. FIGS. 23 and 24 are enlarged portions of FIGS. 21 and 22, respectively.

FIG. 25 is a perspective view, FIG. 26 is an inverted perspective view, and FIG. 27 is an end view of the truss of FIGS. 21-24.

FIG. 28 is a perspective view of a truss system including two truss elements as illustrated in FIGS. 25-27, in which a portion of the upper portion of each truss has not been shown for clarity only.

FIG. 29 is a plan view of a truss according to another embodiment.

FIG. 30 is perspective view of a component of certain embodiments of a truss system.

FIG. 31 is a schematic end view (upper portion of the figure) and plan view (lower portion of the figure) of a component of the first embodiment.

FIGS. 32-34 illustrate embodiments other than boats.

In many of the figures illustrating a boat or similar watercraft, for clarity only, functional components such as fuel tanks and engines, sails, oars, storage compartments, electronics, and the like are omitted. Similarly, docks and other marine structures are not illustrated with accessories that may be included without departing from the scope of the disclosure.

### DETAILED DESCRIPTION

### General

This application describes improved rotationally molded products and methods of making the same. The products are preferably boats and other water-borne structures such as decks, but those are only examples. In general, the rotationally molded article has a compressible truss structure either assembled to the mold and molded into the internal structure of the article, or added to a previously molded article (or portions of the same) and permanently attached in place. An example of such a previously molded article would be a double hulled rotationally molded boat. The truss comprises two portions which are designed to move relative to each other such that the truss as a whole may be compressed (i.e., reduced in its span, or length) when the article undergoes internal or external forces.

To be sure, high-performance rotationally molded boats (and other articles) having molded-in but non-compressible components labeled with the term “truss” are taught and claimed in U.S. Pat. No. 6,460,478 (Widmer). Such constructions, however, rely on a lattice or similar static structure. They therefore are not designed to accommodate the shrinkage of the polymeric material.

In general, as the dimensions of a rotationally molded product increase, the amount of shrinkage increases, and also the amount of deflection (“sag”) in the finished product increases. The compressible truss addresses both of these problems by adding to the strength and rigidity of the finished product.

Note also that while the applications described here primarily address movement and forces along a single (“X”) direction, in general these principles may be applied to any or all of the X, Y, and Z directions depending on the design of the final product, its components, and its method of manufacturing and/or assembly.

Compression and Shrinkage

The thermoplastic materials used in rotational molding are known to cause the molded articles to shrink upon removal from the mold by approximately 5% or less, typically approximately 3% in the case of polyethylene, the most common material. The amount of shrinkage varies from manufacturer to manufacturer of plastic material more so that from batch to batch of the same material. However, once shrinkage is complete, no further shrinkage or expansion is expected under normal circumstances. It is important to remember that due to the rotational molding process, all exposed surfaces of the molded-in truss will be covered with molten plastic material that will cool to direct contact with the truss. Thus, once the molded article has cooled and the compressible truss has contracted, the resulting article is extremely strong not only because of the inherent strength of the truss itself, but also because of the significant amount of surface area represented by the polymer/truss interface.

Once the compressible truss is assembled to the article (or article portions which are subsequently assembled into the article), the combination has significantly greater strength (from the truss) and may be relatively large (such as the 7 meter or greater size mentioned elsewhere) yet when it is exposed to substantial external forces, the compressibility of the truss keeps the assembly from being too stiff to absorb the applied forces.

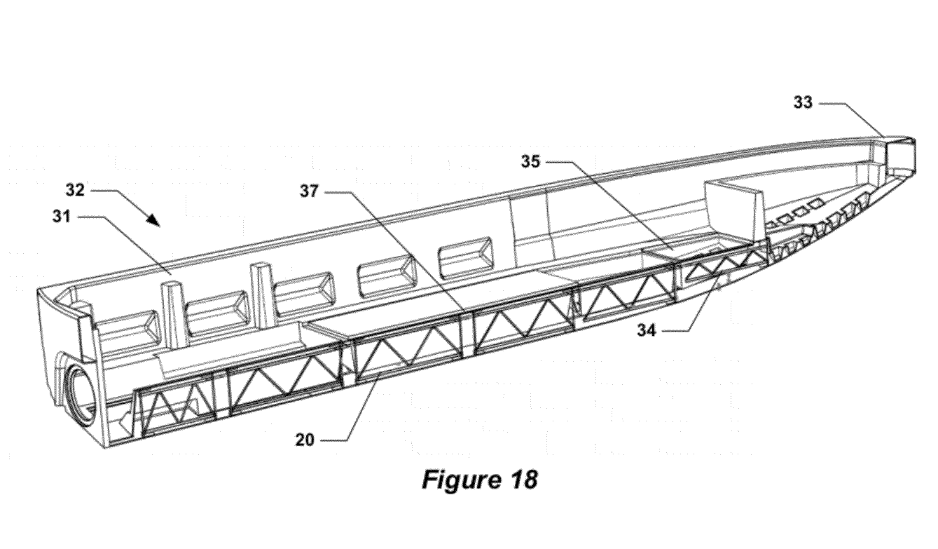

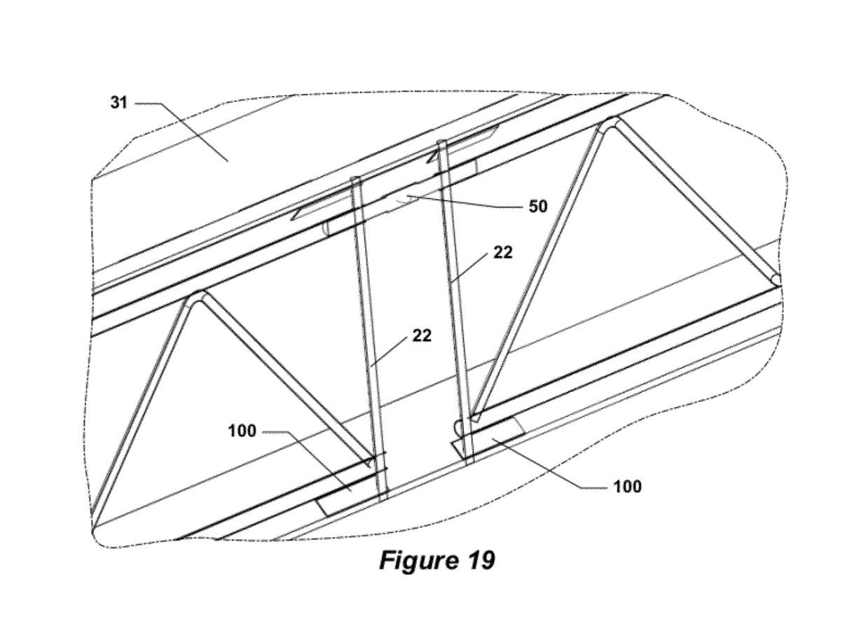

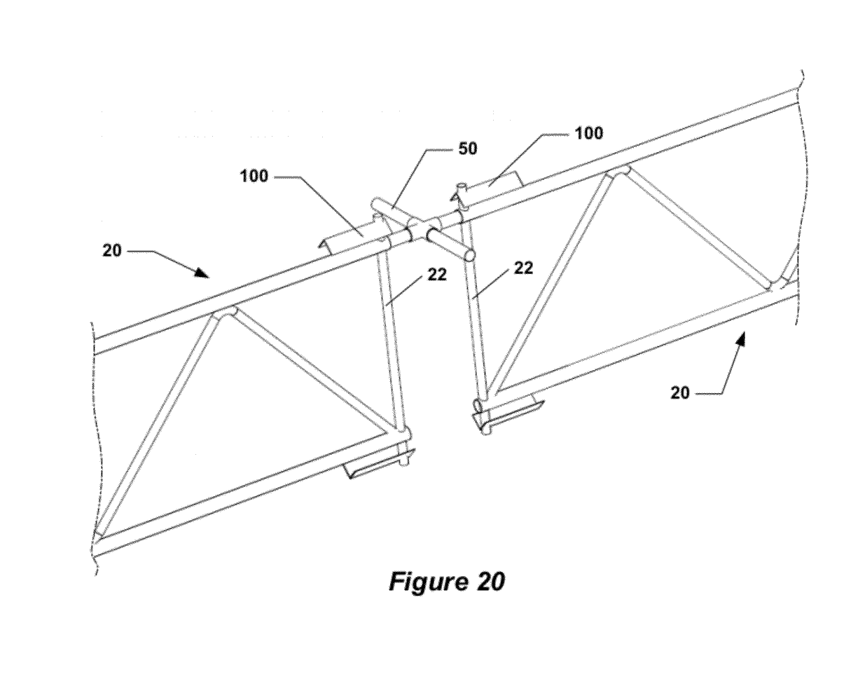

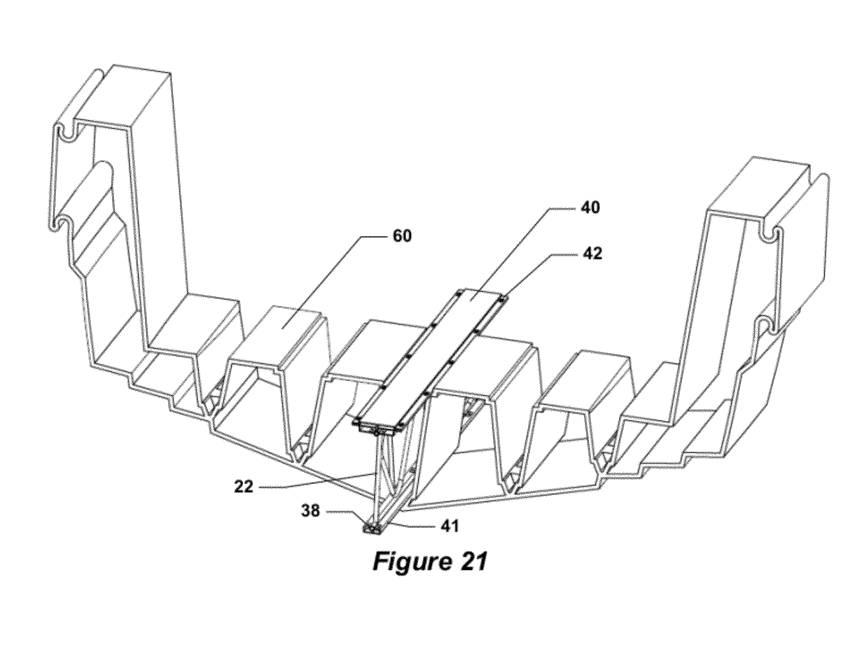

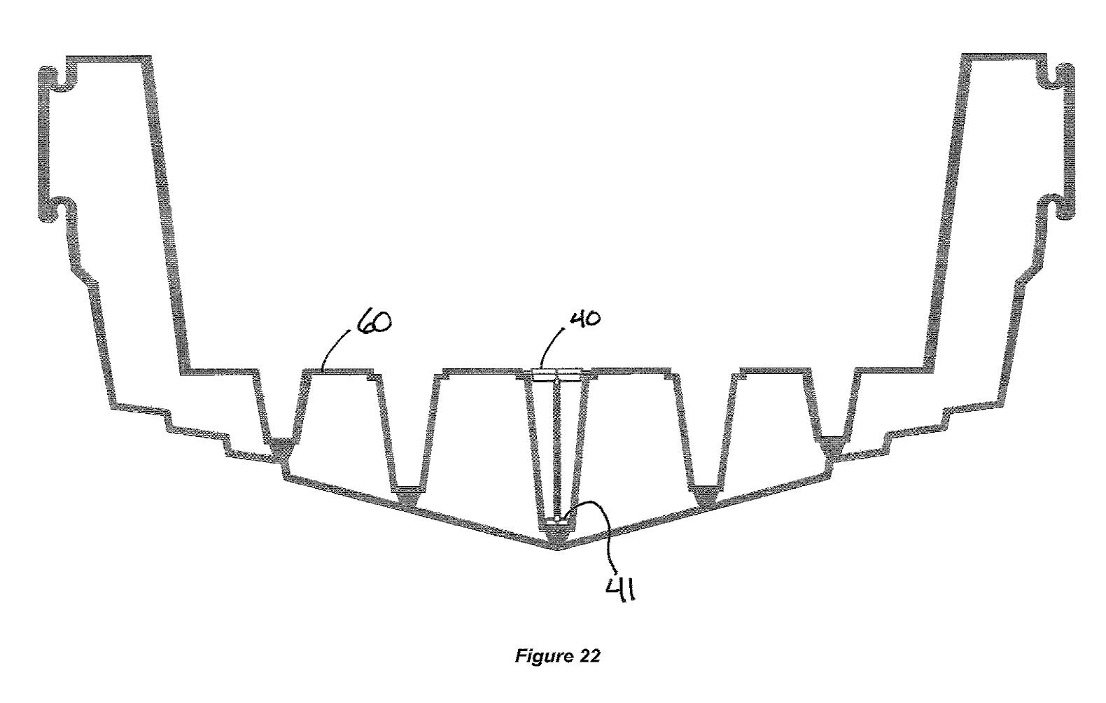

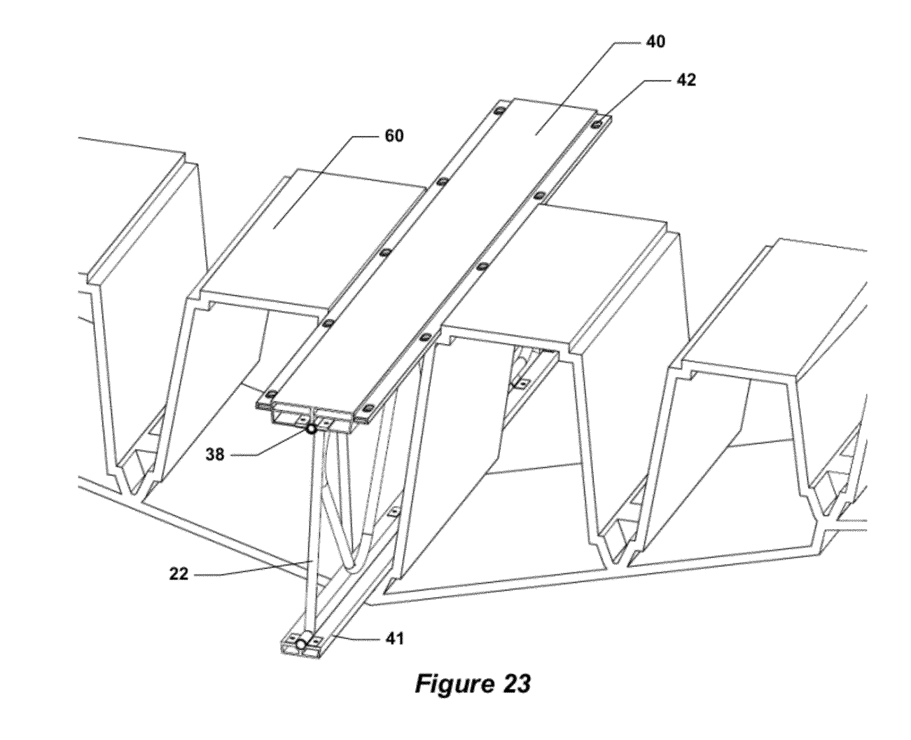

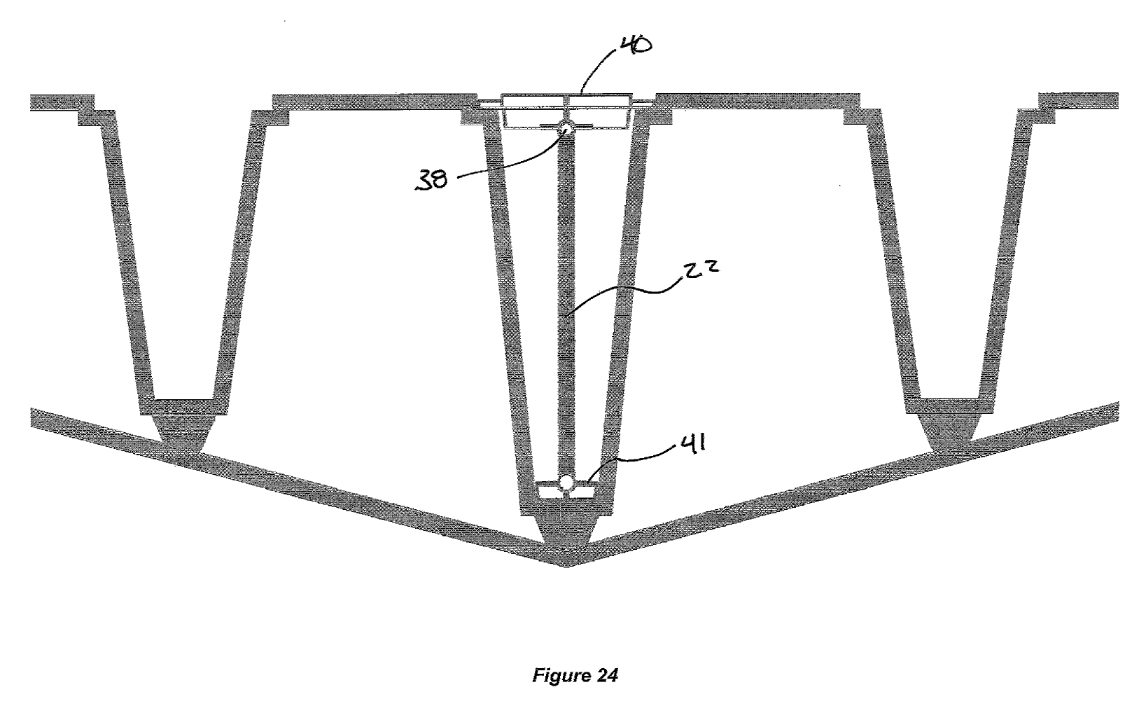

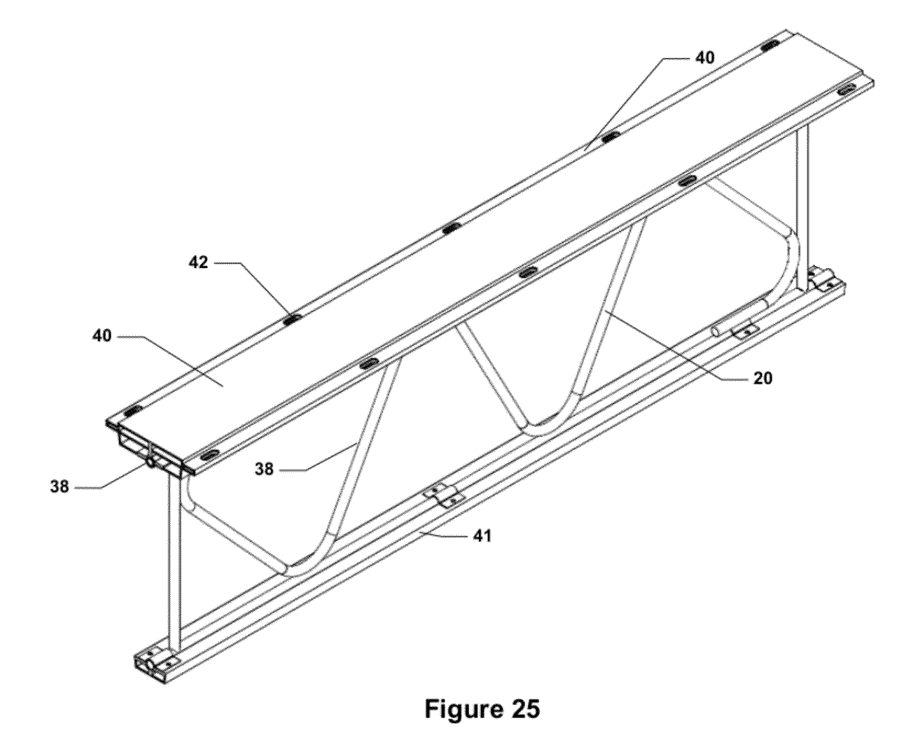

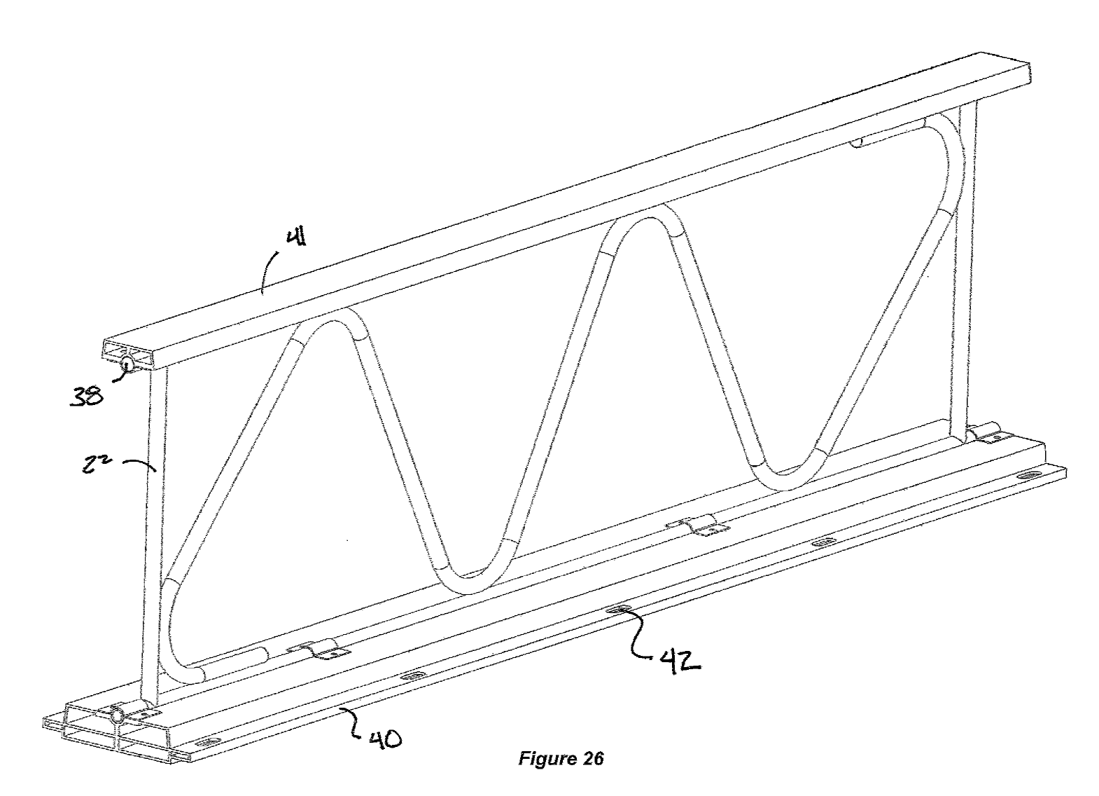

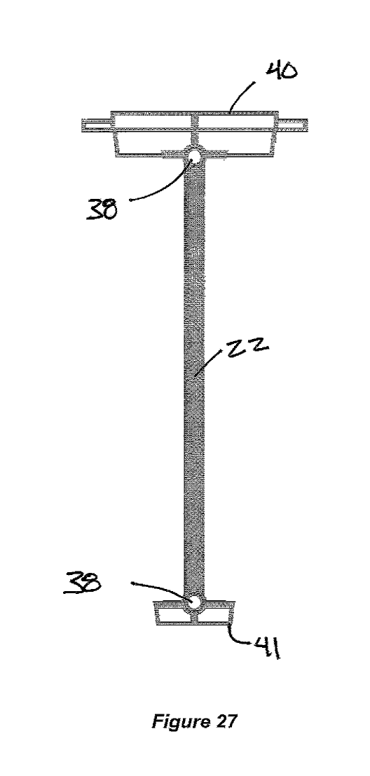

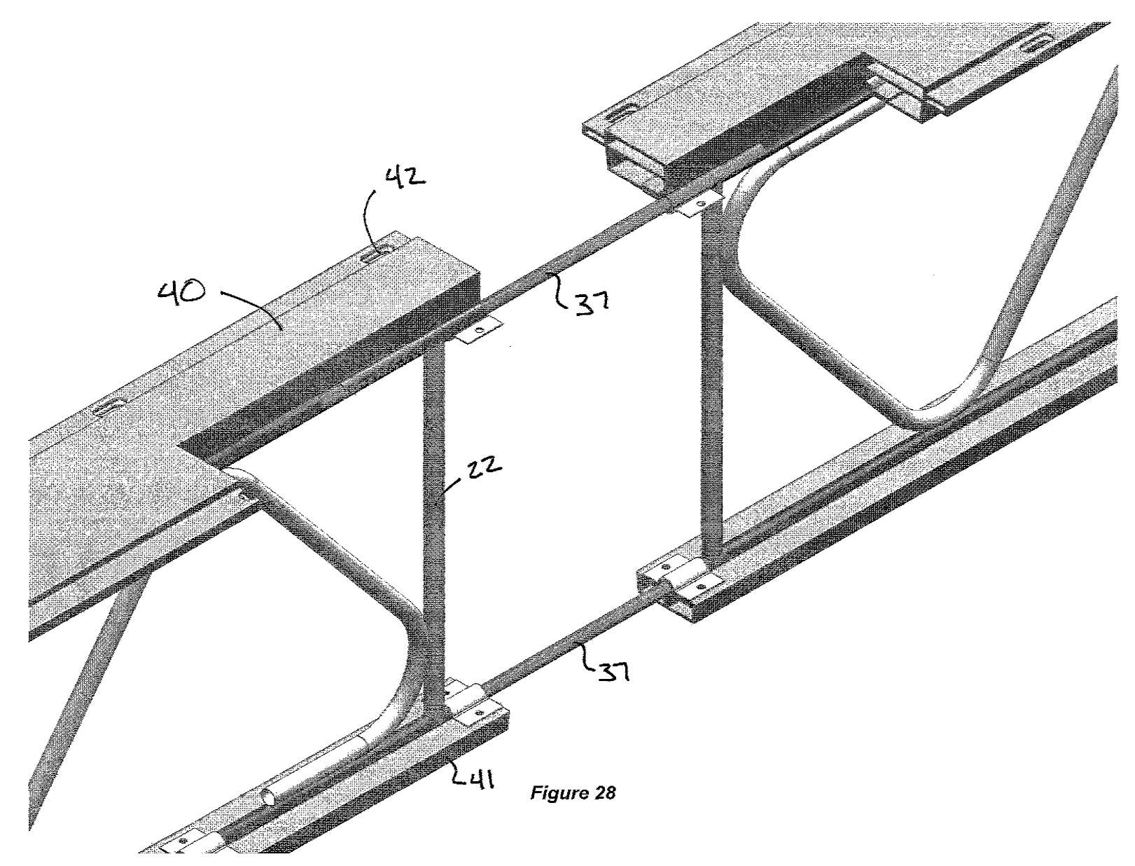

Regions of compressibility may be “free” (not attached to molded plastic) or attached in one or both directions perpendicular to the axis of compression. Compression pins could be T-shaped or X-shaped or even more complicated shapes as required. For example, FIGS. 18-20 (especially FIG. 20) illustrate the use of an X-shaped compression pin.

As illustrated, compressibility of the truss as a whole comes from the relative motion toward each other of the two truss portions. At least one (preferably, both) of the upper and lower chords comprises a pin and socket arrangement. The pin may be fixed to the chord of one truss member and slide within the socket of the other truss member, or the pin may “float” or slide within sockets on each truss member. In either case, the two truss members may move toward each other when subject to forces tending to move them together. Because the compressibility of the truss provides a single degree of freedom for the molded article to shrink during cooling of the material, those components of bending or warping forces are reduced if not eliminated.

### Truss Geometry

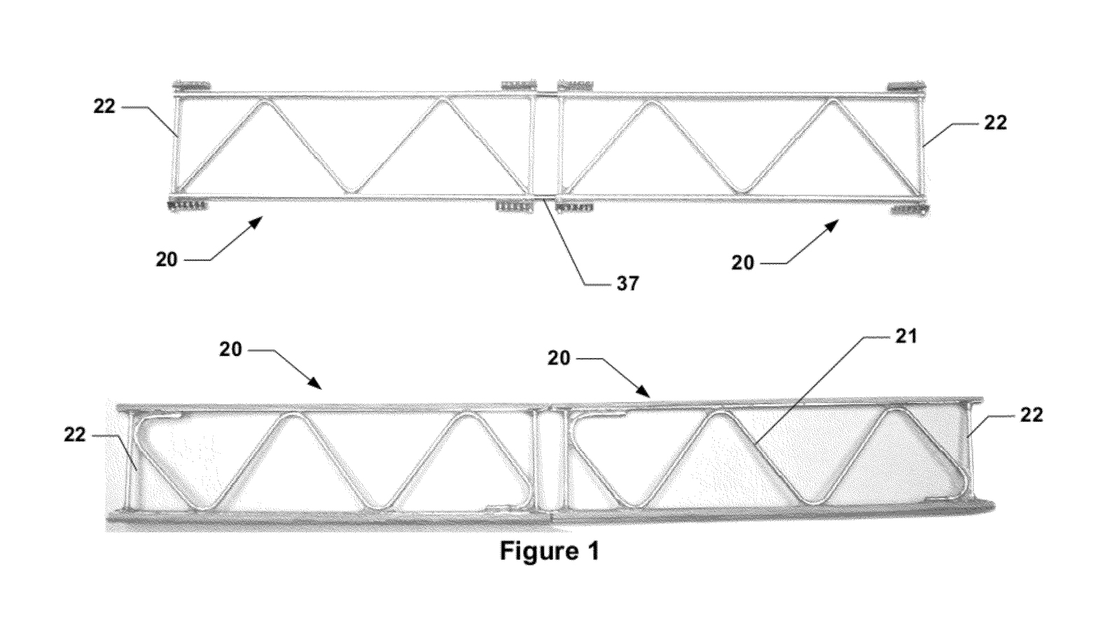

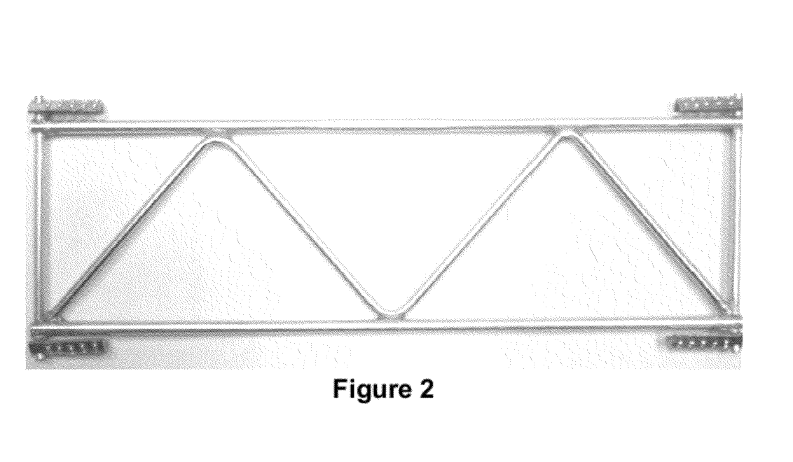

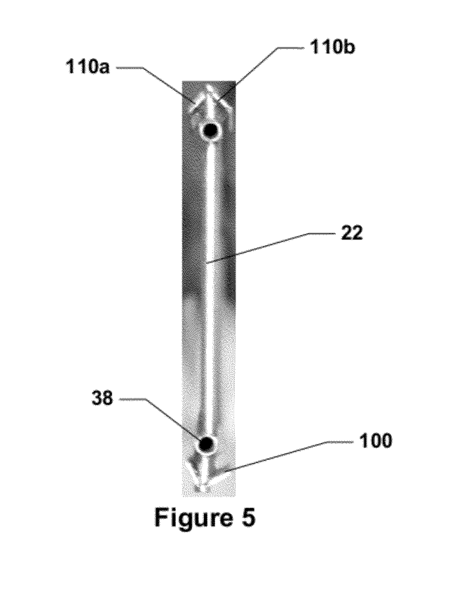

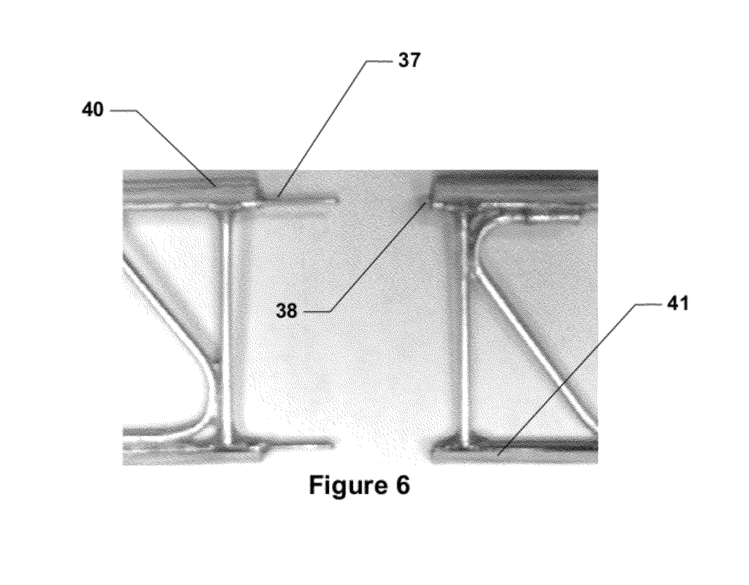

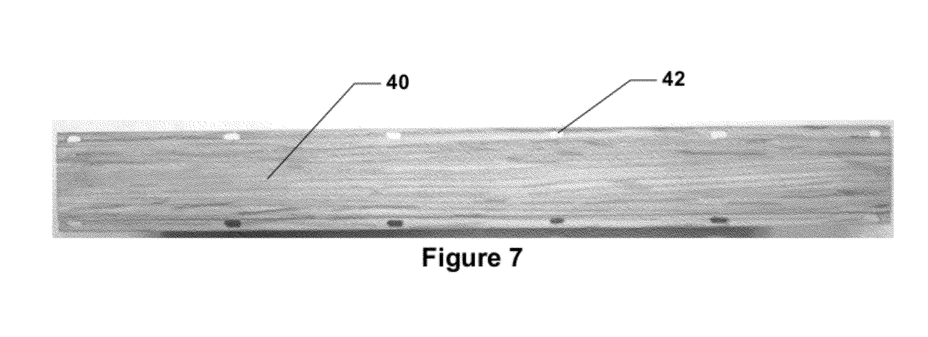

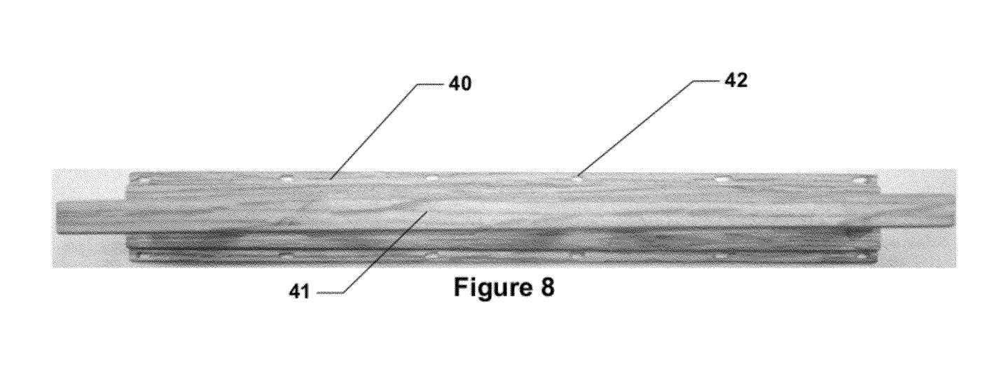

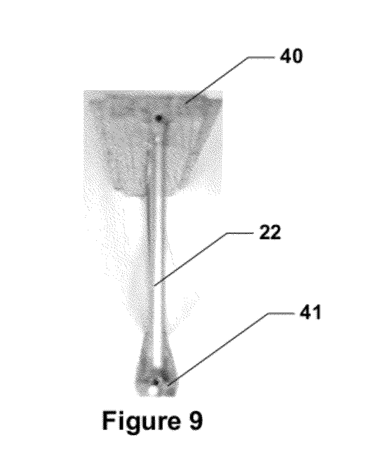

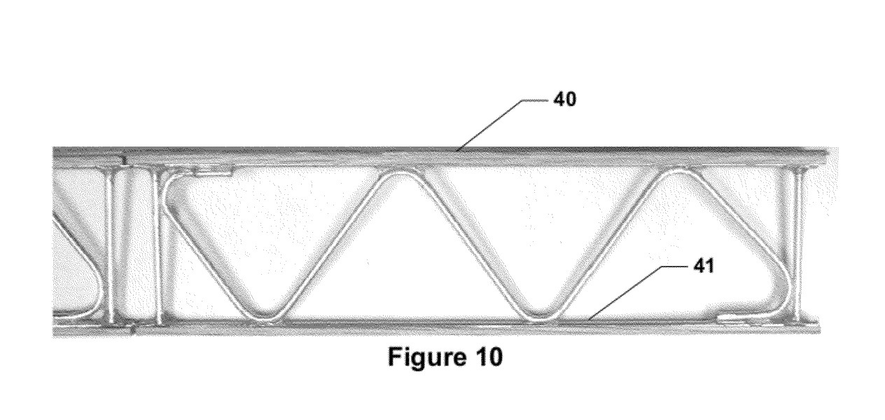

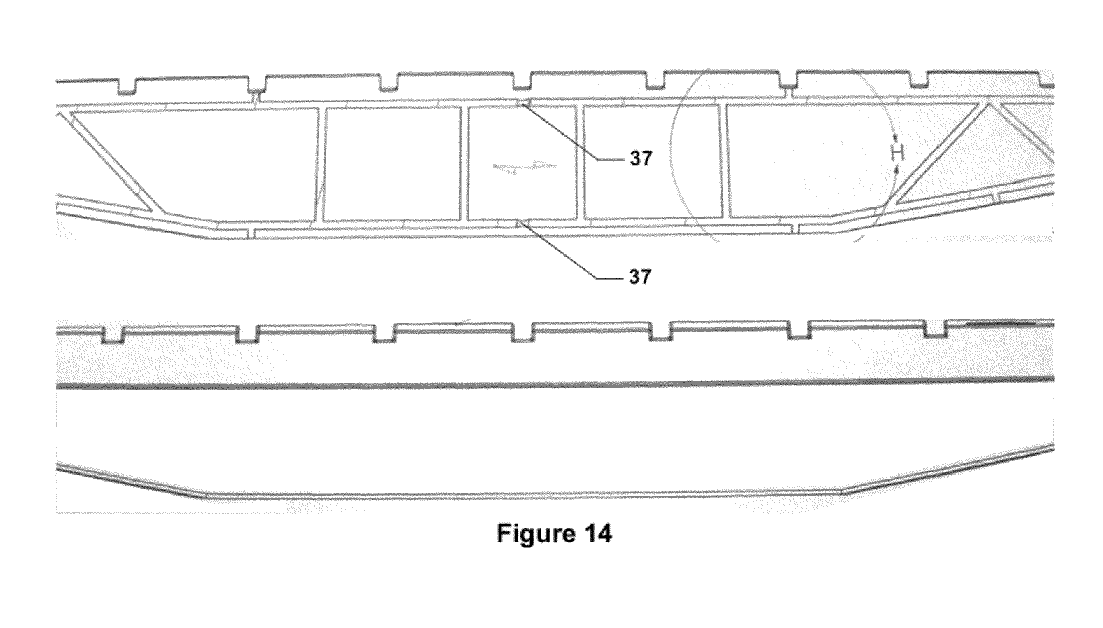

The examples of truss shown here are planar trusses, which are preferred. Three-dimensional space frame trusses are possible provided they compress along their length as described. In particular, the Warren truss 20 illustrated in FIGS. 1-10 is desirable because its individual members 21 (forming equilateral triangles) support only tension or compression and not bending or torsion; there are no vertical elements (save at the ends of each section, such elements denoted as 22), thus it uses relatively little materials and therefore is relatively light for the amount of strength it provides. However, in general, the type of truss (i.e., the configuration of the various members) is not critical. It is the compressible nature of the two portions of the truss that provides the advantages. Thus, for example, as FIGS. 13-15 illustrate, the truss may have non-parallel chords 23. The truss may be adapted to the needs or intended use of the article to which it is applied.

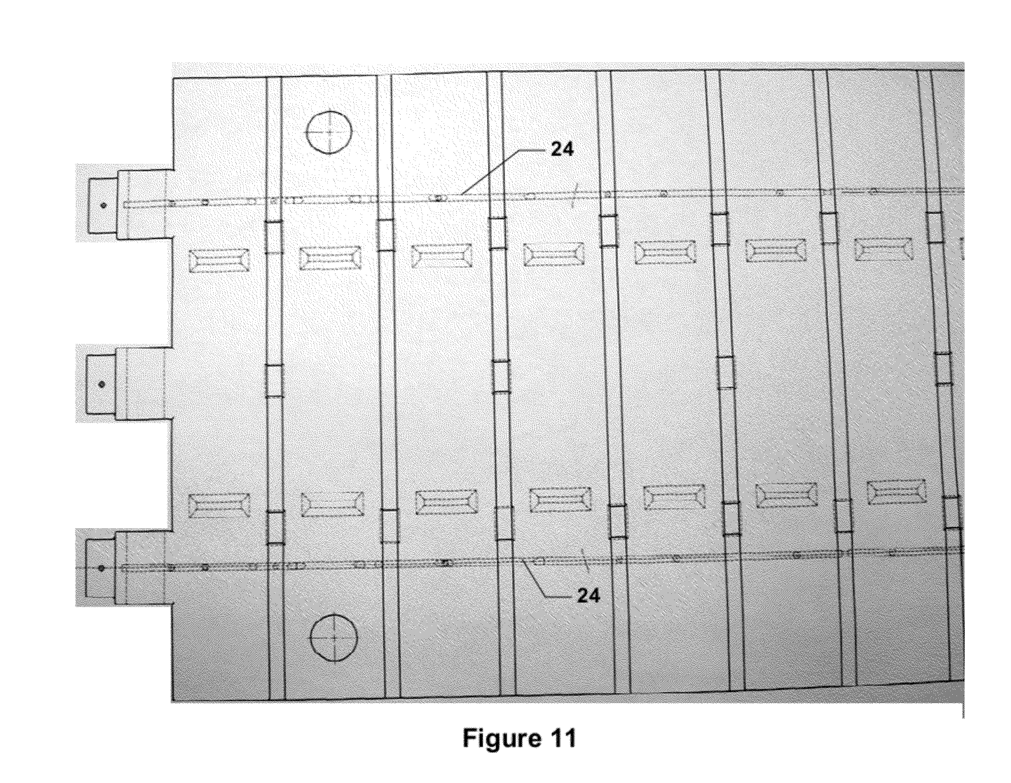

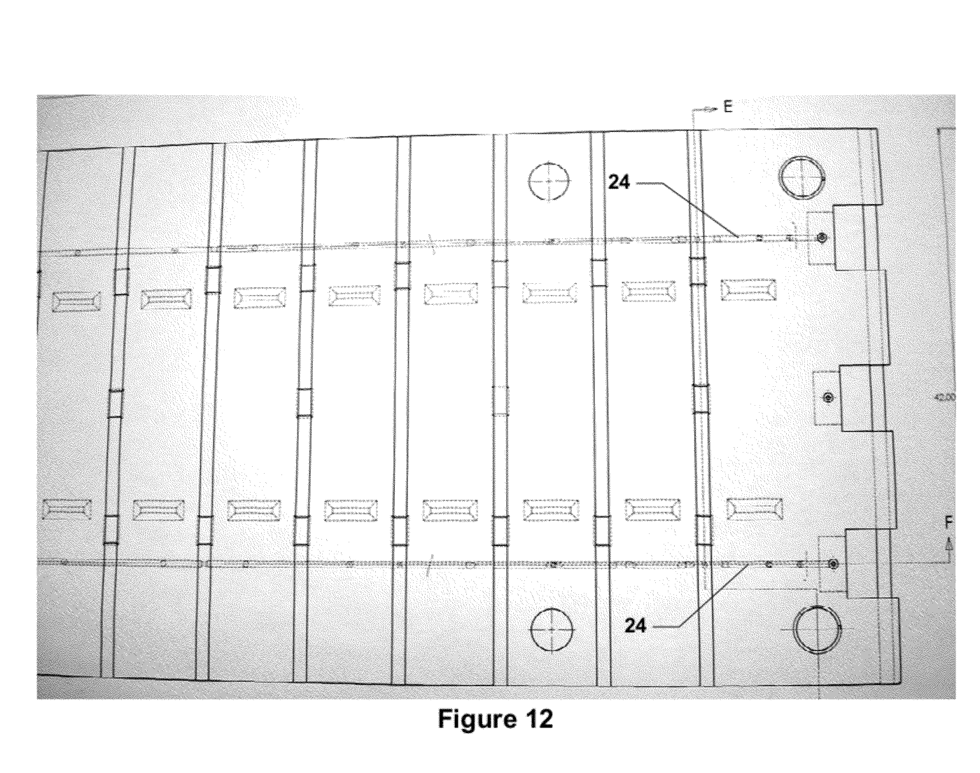

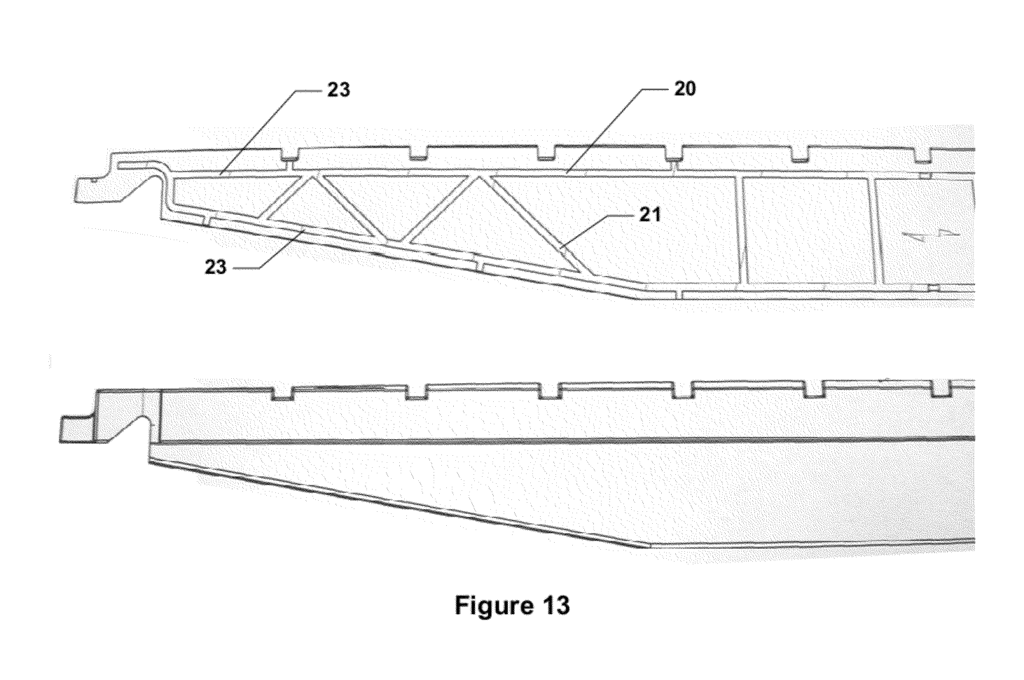

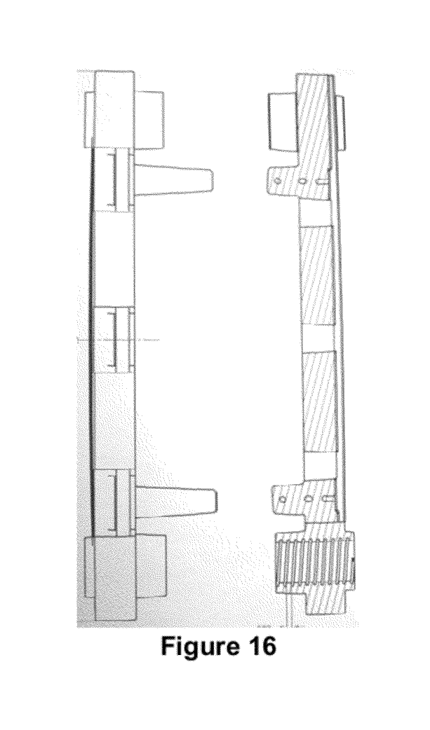

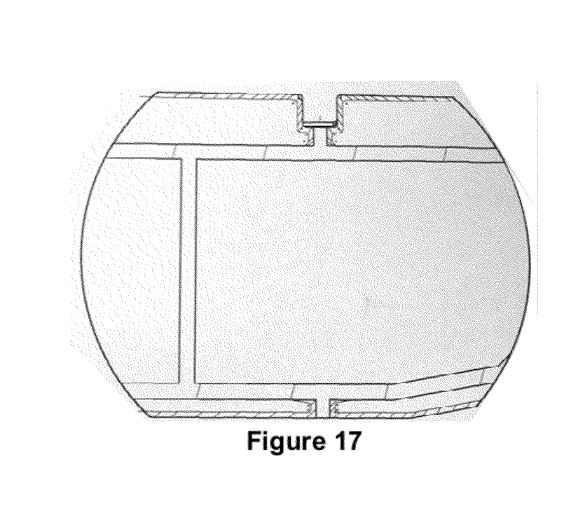

It is also possible for a single article to have more than one compressible truss (or truss system). For example, referring to FIGS. 11 and 12, the third embodiment has two compressible trusses 24 to provide stability over its relatively wide width of 42 inches [106.7 cm] (see FIG. 16).

Similarly, while each of the three embodiments in FIGS. 1-12 show a truss system having a pair of truss sections connected by pin(s) 37, and therefore a single region of compressibility between them, other multi-sectional truss systems may have three or more sections and thus two or more regions of compressibility.

Typical lengths for the tubular Warren-type trusses illustrated here are on the order of approximately 1.25 meter (approximately forty-eight inches). Typical heights are on the order of 17.8 cm (seven inches). These are only examples as the dimensions will depend on the article and its intended use.

Where tubing bends encounter straight tubing, welds or other features to increase the strength of each truss may be provided.

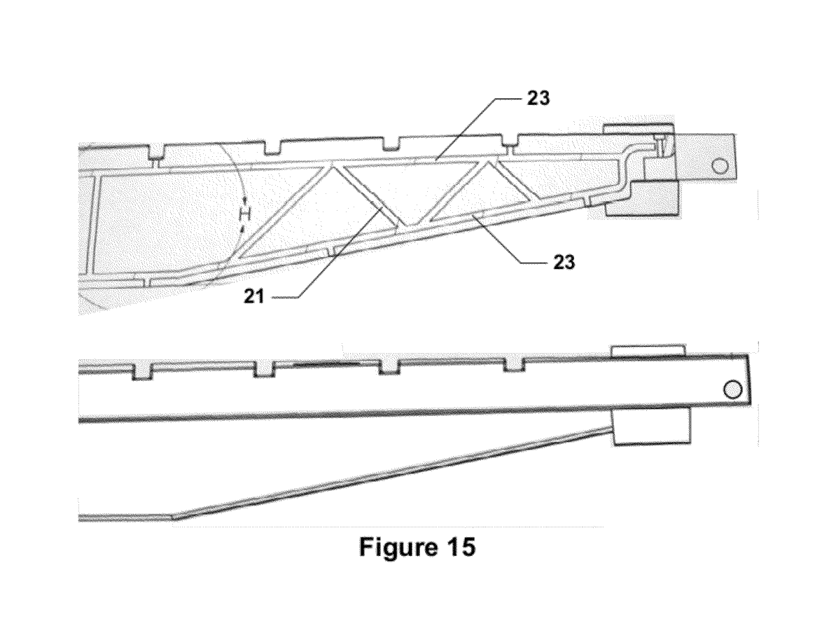

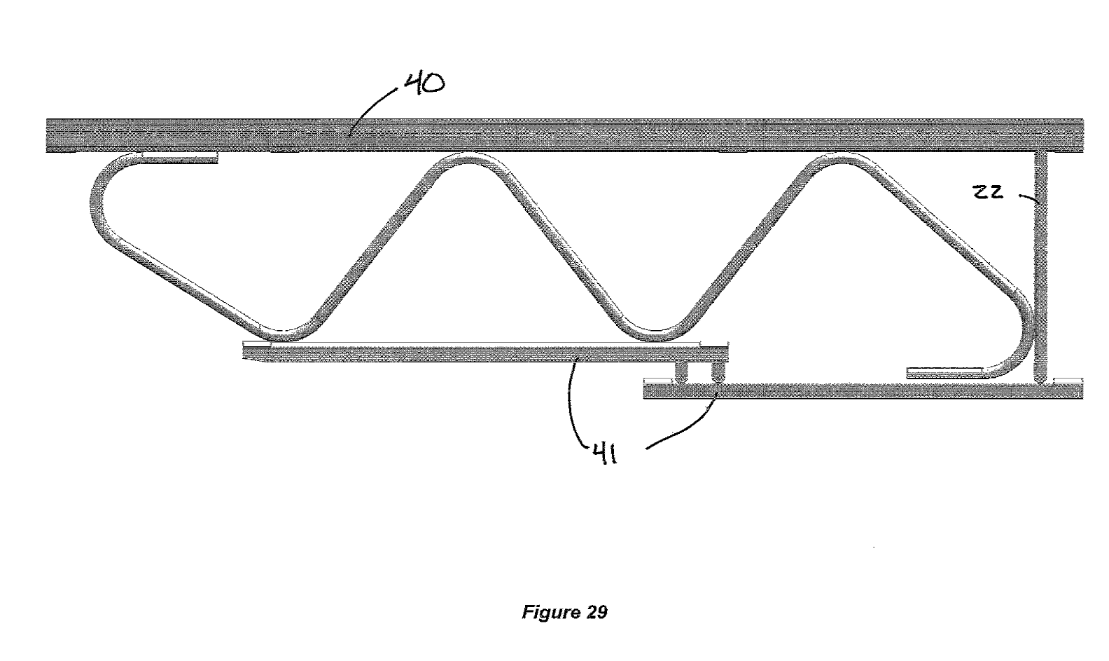

As illustrated in FIG. 29, some embodiments of the truss are staggered or otherwise dimensioned to accommodate changes in the height of the truss required by changes in the shape of the body into which it is placed. For example, as seen in FIG. 18, as the hull 31 of a boat 32 slopes upward proceeding towards the bow 33 of the boat, the height of the truss is reduced to keep the upper surface of the truss at the same level. Another example is illustrated in either of FIGS. 13 and 15, at the opposite sides of the deck embodiment of FIGS. 11-17.

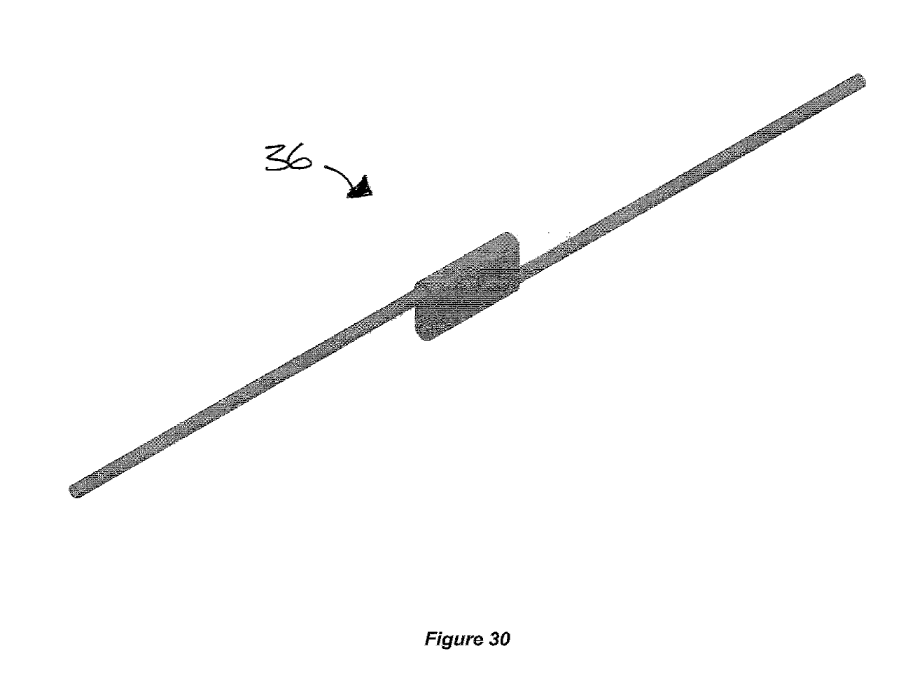

This in turn may require that two adjacent truss members be joined by a Z-shaped member, an example of which is shown in FIG. 30 as 36. Of course, other shapes besides the Z-shape may be employed depending on the circumstances.

In the “drop-in” embodiment, it is preferred to bolt or otherwise attach the aft end of a truss (or the aft section of a truss system) to other structural members of the boat.

### Materials

In general, the truss members may be formed of any material providing sufficient balance of cost, strength, weight, ease of handling, and the like.

For many applications, as illustrated here, the truss members between the upper and lower chords may be assembled from aluminum tubing or similar materials. The upper and lower chords may be assembled from extruded aluminum or similar materials. Typical dimensions for the boats of this application include: aluminum tubing outer diameter of 15.88 mm (0.625 inch) and wall thickness of 0.89 mm (0.035 inch); tubing type 6061-T. The aluminum extrusions may have “tube thickness” values on the order of 2.54 to 6.35 mm (0.1 to 0.25 inch) thick. These are only examples as the dimensions will depend on the article and its intended use.

The tubing need not be circular in diameter, although that is preferred for the applications illustrated here. In general, the tubing could have hexagonal, square, rectangular, or other cross-sectional geometry. A similar statement applies to the compression pin(s).

The compression pin(s) 37 could be solid or hollow (tubular).

The compression pins 37 and/or the inside diameters of recesses or similar features 38 associated with any truss members relative to which they move (i.e., typically but not necessarily the inner diameter of the tubing), may be coated with “non-stick” or other low-friction materials, such as polytetrafluoroethylene (PTFE), perfluoroalkoxy (PFA), or fluorinated ethylene propylene (FEP) (all available under the tradename TEFLON); or other materials with similar low-friction properties.

In the “added-in” embodiment, upper 40 and lower 41 attachment plates (formed from, for example, extruded metal such as aluminum) are welded or otherwise attached to upper and lower chords of the truss portions. When the chords are formed from aluminum tubing, clamps are adequate. Grooves are desirable to improve the fit of the tubing to the attachment plates. The attachment plates may be solid or hollow as desired. They may have uniform or varying cross-sectional profile. Such profiles may include recessed portions or flanges or similar features to ensure that they fit properly against surfaces of the rotationally molded article. The attachment plates may have holes or other features 42 supporting connection to portions of the molded article 60 (illustrated here as a boat hull only by way of example). For example, if threaded nuts or similar features are molded into the article 60, the attachment plates 40, 41 may be bolted to the article 60 though the holes 42. Other means for attaching the attachment plates 40, 41 to the article portions are equivalent.

Preferred molding materials for high performance watercraft and similar applications are high density cross-linked polyethylenes (HDXLPE), which are commercially available. Other materials known to be suitable for rotational molding may also be used, including the less costly (but less strong) high density polyethylenes (HDPE) which are also commercially available.

The strength provided by the truss system enables boats as described here to be rotationally molded with wall thicknesses that are believed to be less than 22.225 mm (0.875 inch) on the outer hull in the lowest area, and are further believed to be less than 15.875 mm (0.625 inch) on the inside hull walls. It is preferred to use decreased thicknesses to reduce weight and cost, and therefore these values are only examples. (Note also that different inside and outside wall thicknesses are often preferred. They may be achieved by shielding one side of the mold with insulation to reduce the buildup of material on that side during rotational molding. Of course, in general, the thickness(es) of the article walls will vary in size depending on the ultimate size and other requirements of the finished product, which need not be a boat.)

Yet the boats are substantially lighter—on the order of 1,500 kg (680 pounds)—compared to boats of comparable strength manufactured in other ways.

### Bonding Plates

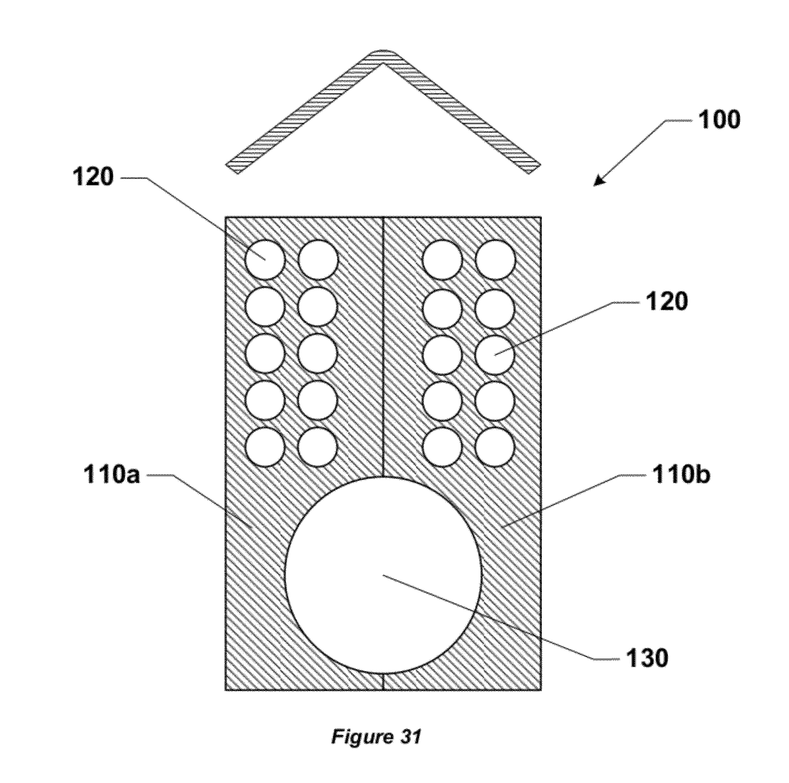

In the molded-in embodiment, to increase the amount of bonding between the plastic and the compressible truss, it is desired to attach bonding plates at each of the four corners of each truss section as illustrated in FIGS. 1-5. As further shown in FIG. 31, in the most preferred embodiment, each bonding plate 100 comprises two flat portions 110a-b angled with respect to each other to form a V-shaped cross-section (the upper portion of the figure); in each portions, a plurality of holes 120 is drilled or otherwise formed. Thus, the molten plastic material freely flows through the holes 120 to surround the entire plate. The holes 120 also increase the surface area of the plate-plastic interface.

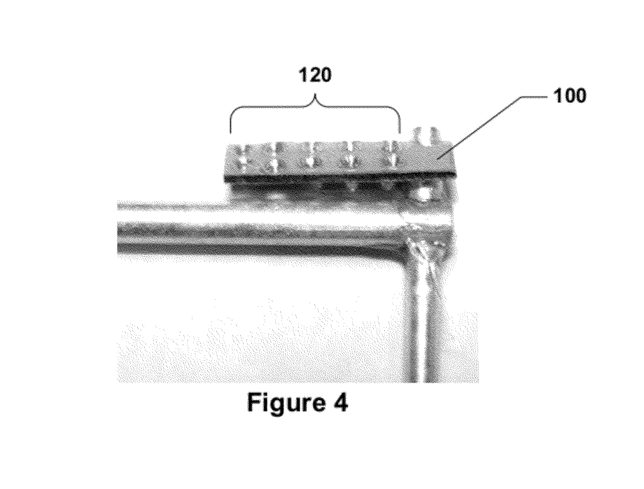

As shown in FIG. 4, each bonding plate is located slightly away from the upper or lower chords of the truss to allow for improved flow of molten plastic material underneath the plate without interfering with the compression of the two truss sections together. This may be accomplished by extending the vertical end member of each truss portion so that the bonding plates may be attached by using (in the embodiment illustrated in FIG. 31) mounting hole 130, for example, to the portion that extends beyond the chord. Other forms of attachment are suitable.

This arrangement also provides another advantage. The vertical end member may extend even further away from the truss member than the bonding plates. This provides the locations for attaching the truss member to the interior of the mold as described above. The inner surfaces of the vertical end members may be threaded or otherwise adapted for connectors that will hold the truss members in place during the rotational molding process.

In maritime applications, the plates are preferably attached to the boat hull or similar structure by corrosion-resistant members such as stainless-steel or galvanized steel bolts (mating nuts or other features could be molded into the article, or self-tapping bolts could be used). The size will depend on the application.

### Molding Process

Rotational molding of objects, such as boat hulls, is not new. In the case of boats, the process produces a hollow boat hull with an inner and outer walls. The hollow space in between is conveniently filled with foam for purposes of buoyancy and strength. The inner and outer walls are desirably connected for purposes of rigidity of the structure. This is usually accomplished along one or more ribs that run lengthwise of the hull. The rib is formed by closing the mold during the rotational molding process in order to bring together and fuse projecting opposing surfaces. This process is described in U.S. Pat. No. 3,663,680 issued May 16, 1972 to Ringdal, the entire contents of which are incorporated by reference.

Generally speaking, rotational molding involves placing a solid or liquid polymer in a mold; the mold is heated and then cooled while being rotated about two perpendicular axes simultaneously. During the first portion of the heating stage when molding with powdered material, a porous skin is formed on the mold surface. This gradually melts as the cycle progresses to form a homogeneous layer of uniform thickness adhering to the mold's surface. When molding a liquid material, it tends to flow and coat the mold's surface until the gel temperature of the resin is reached, at which time all flow ceases. The shape of the object being molded conforms to the inside surfaces of the mold. The structure is hollow between the molded surfaces. When all flow ceases, the mold is indexed to a cooling station, where the mold is cooled. It is then positioned in a work zone, where the mold is opened, the finished part removed, and the mold recharged for the next cycle.

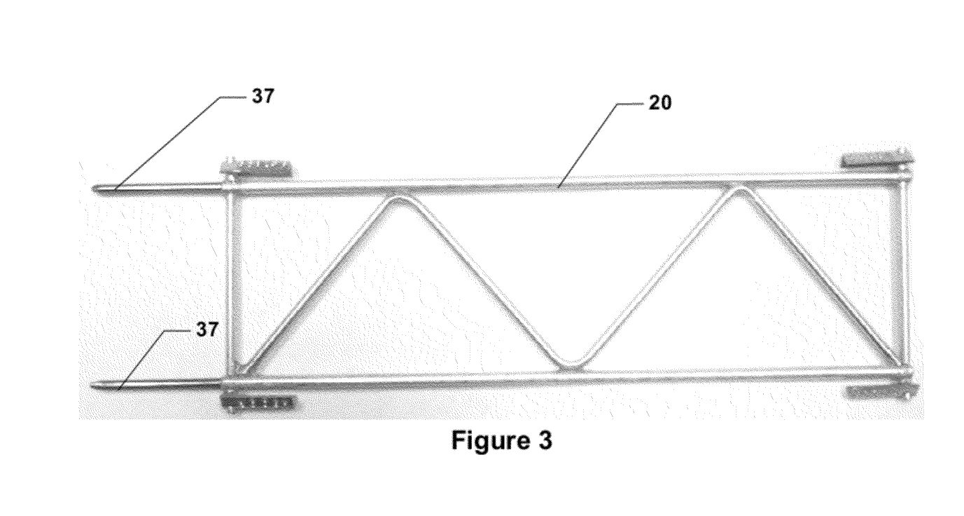

More specifically, the molding process according to the method of making a hollow walled structure can be seen in FIGS. 3 through 7 of U.S. Pat. 6,460,478 (Widmer), the entire contents of which are incorporated by reference. A mold is provided having first and second mold sections of a rotational molding type. The sections are closed, forming a shape bounded by confronting interior mold walls according to the intended shape of the object being manufactured. One mold section has a surface for forming a first wall. The other mold section has a surface for forming a second wall. One surface has one or more rows of V-shaped indentations. The indentations have apexes that project toward the other molded surface. The apex forms a constriction between the mold surfaces. The constriction is of such a size that it will be filled with molten material during the molding process. This will harden to form a connection between the confronting walls of the structure being manufactured. The aligned indentations are spaced apart along a channel thus providing intervals in the channel between the joints to permit flow of molten material between them to the remainder of the mold.

Referring specifically to FIG. 3 of U.S. Pat. No. 6,460,478 (Widmer), which shows the upper and lower mold sections closed, thermoplastic material is introduced into the cavity of the closed mold. The mold is heated and rotated in the usual rotational molding process. Flowing material adheres to and coats the interior mold surfaces, forming walls of the object being manufactured. The thermoplastic material fills the region of constriction between the apex of an indentation on one mold wall and the opposite mold wall. Thermoplastic material flows around the ends of the indentation to travel to other mold portions. The constrictions do not inhibit the molding process. After the plastic has been introduced into the mold and heated, then cooled, a foam material can be introduced into the spaces between the molded walls. Upon completion, the mold is opened and the molded structure is removed. In the case of the boat illustrated, a large number of molded joints are located in the various parallel channels. The bonding of the inner and outer hull walls stabilizes and strengthens the hull. The resultant boat hull is strong, resists buckling, and is economical to manufacture.

The molded connectors are formed during the molding process. The mold has two or more sections that are assembled or closed for the manufacturing process. Selected mold surfaces involved in the formation of the hollow-walled structure are provided with V-shaped indentations that project into the space between one mold surface and an opposing mold surface. The projecting members form a constriction between the two mold surfaces so that molten material fills the space to form a molten joint. The indentations are short and are spaced apart along a row. During molding, molten material flows between the indentations so as not to obstruct the process of molding the entire structure. One or more rows of such molded connecting joints are formed, greatly enhancing the structural integrity of the molded object.

A boat molded by such a process has hollow side walls and a hollow bottom wall formed of an inner bottom wall component and an outer bottom wall component. The bottom wall components are connected by the spaced apart molded joints. The boat can be a bass fishing boat, a duck boat, a pontoon boat, sail boat or a normal utility boat. The inner wall of the boat can be molded according to the requirements of the boat. For example, a bass fishing boat can have a number of compartments, a motor well and a bulkhead for mounting a steering assembly and various instrumentation. Other objects that can be molded include pontoons for a pontoon boat, dock sections and other such hollow walled structures.

In terms of a boat hull, the truss or trusses to be molded-in are manufactured separately and then attached to the mold that will form the boat hull, such as by bolts or other (possibly threaded) connectors that extend into the mold cavity and are adapted to hold the truss or trusses in place. Each truss is thus connected to the inner mold, and any compression pins are properly placed in their sockets, before the mold is closed.

The truss is spaced away from the mold walls prior to closing the mold to ensure that molded plastic properly forms between the truss and the mold walls. The mounting of the truss inside the mold must prevent the truss from moving as the mold is rotated and turned.

When the rotational molding process begins, the thermoplastic material bonds the intended portions of the truss to the boat hull formed by the rotational molding process.

After the molding process is complete and the molded boat removed from the mold, which also involves unbolting or otherwise detaching the now-molded boat hull from the inside of the mold, there are holes from the connectors on the outside lower hull surface and other locations. A plastic screw or other plug easily fills these holes without compromising the buoyancy of the boat.

The molding process can be employed to produce other rotationally molded, hollow-walled articles such as sections of a boat dock, or pontoons for a pontoon boat. Other articles that are not intended for marine application are also suitable articles for the molding process.

### Applications

In addition to the applications noted above, specifically preferred applications are boats which are required to withstand blast, impact, and/or structural loads when they are used to blow up mines, when moving through rough seas at high speed and/or when they are hoisted aboard another structure (e.g. another vessel or a platform). Standard hull designs currently used by naval forces and others requiring such performance are made of aluminum or fiberglass. Aluminum hulls do not withstand successive blasts well, and fiberglass hulls break when moving through rough seas at speeds as low as 30 knots [55.6 km/h (or 15.4 m/s)]. The watercraft described here are more flexible (less breakable) and thus more resistant to impacts from blasts and waves, unsinkable, resilient to small arms fire, and cost effective to manufacture despite their relatively large size compared to conventional rotationally molded articles.

Although the principles above are described and illustrated primarily with respect to boats and other watercraft, docks, and the like, such articles are only examples. Components of structures could also be such articles. For example, walls or roofs of buildings and similar structures are possible, as are portions of containers, transportation vehicles, and the like.

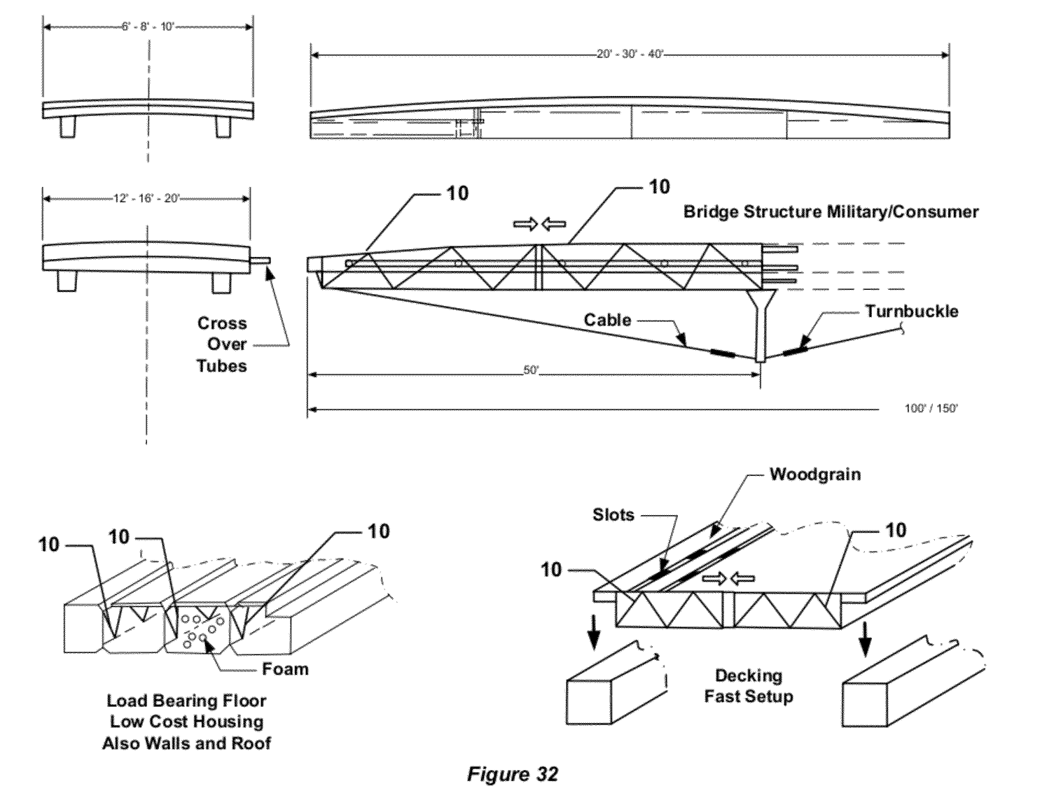

Examples of possible other structures are illustrated in FIGS. 32-34. The strength and reduced weight provided by the sliding truss system permit the manufacture and use of structures previously believed to “too big” for manufacture and use.

Examples include military or civilian bridge structures, as illustrated in FIG. 32. Trusses 10 move toward each other as schematically indicated by the arrows. Similar examples illustrated in FIG. 32 include load bearing floors, walls, and roofs for low cost housing, and deck planks.

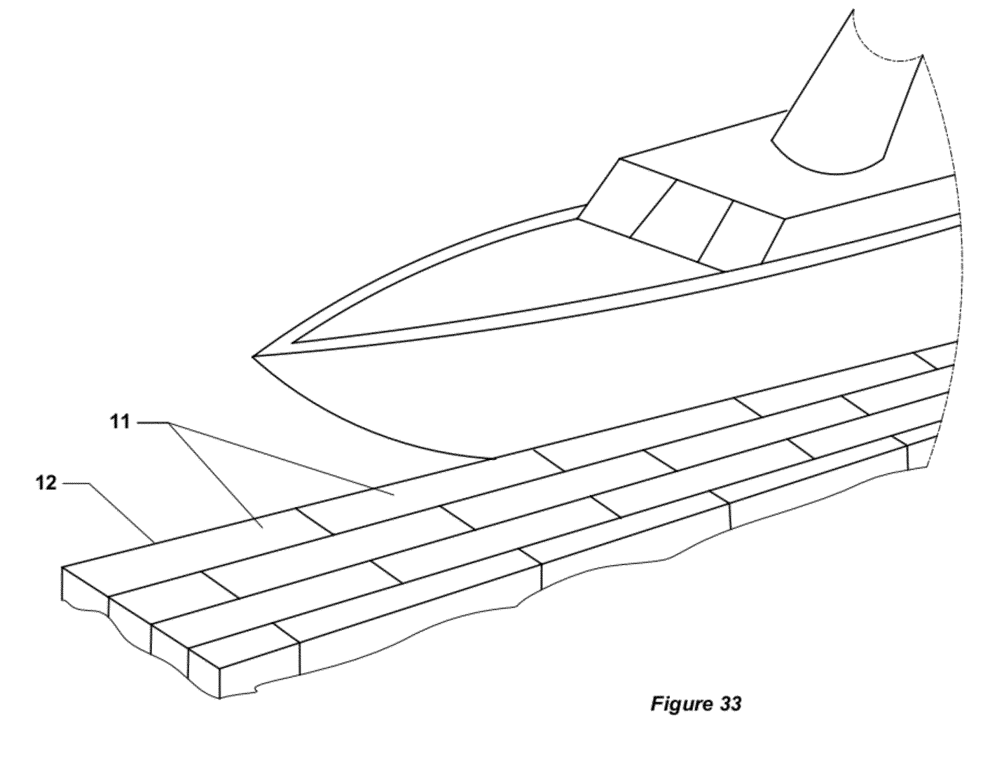

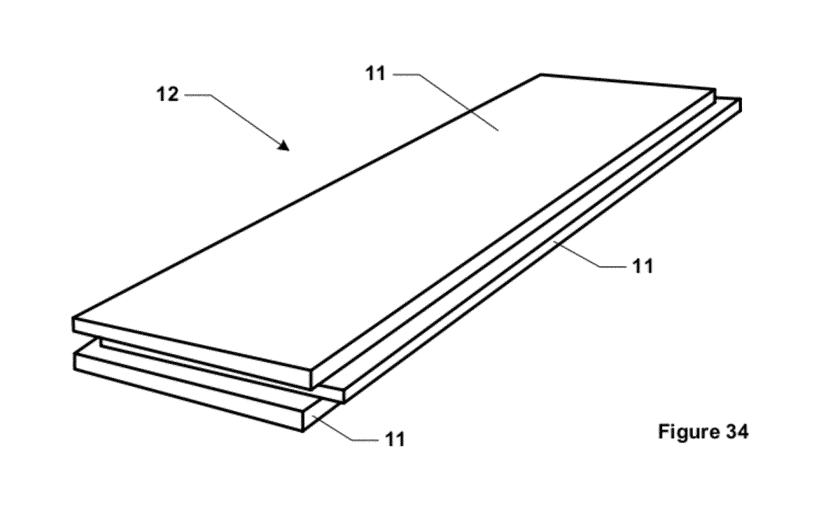

Further examples include the connectable sections 11 of floating platform 12 illustrated in FIGS. 33 and 34. These may be approximately 3.5 meter by approximately 7.75 meter (11.5 feet by 25.4 feet) and approximately 3.5 meter by approximately 15.25 meter (11.5 feet by 50.0 feet). These platforms take advantage of the inherent buoyancy of hollow molded plastic articles yet because of the sliding truss(es) within them, they are strong enough to support substantial weight (such as a vehicle, not shown). Such platforms could easily be stacked (see especially FIG. 34) or otherwise arranged to be joined together as required; for example, a surface pattern or grid could be molded into the top and bottom surfaces of the sections so that they interlocked with each other. A suitable pattern could be lengthwise running channels of ¼ inch depth and ⅝ inch width. Such platforms could be used as modular floating deck platforms in shipyards, ports, and other similar installations involving large marine vehicles or equipment (e.g., platforms for measurement or other types of equipment).

In any embodiment, it is possible to include molded-through or molded-in holes or channels or other features for drainage, or for attachment of other structures, accessories, etc.

In any embodiment, it is possible to include conventional foam materials within some of all of the interior of an article.

### Summary of Embodiments

Based on the description above, at least the following embodiments are contemplated:

(a) A rotationally molded article comprising a compressible truss, substantially as illustrated and described.

(b) A process of forming a rotationally molded article comprising a compressible truss, substantially as illustrated and described.

(c) A rotational mold for an article comprising a compressible truss, substantially as illustrated and described.

(d) A compressible truss for rotational molding, as substantially shown and described.

(e) A method of using a compressible truss in a rotationally molded article, as substantially shown and described.

(f) A combination of a rotationally molded article and a compressible truss, as substantially shown and described.

(g) A process of combining a compressible truss with a rotational mold for an article, as substantially shown and described.

(h) A process of combining a compressible truss with a rotationally molded article, as substantially shown and described.

(i) The article, mold, method, combination, or process of any of the preceding embodiments (a) to (h), in which the article is a hollow walled boat.

(j) The article, mold, method, combination, or process of any of the preceding embodiments (a) to (i), further comprising at least one connecting joint connecting two components of the article, each connecting joint comprised as a downwardly directed V-shaped indentation with an apex that is bonded during the rotational molding process.

(k) The article, mold, method, combination, or process of any of embodiments (a)-(j), in which the compressible truss is added to a rotationally molded article after the article has been rotationally molded and cooled.

(l) The article, mold, method, combination, or process of any of embodiments (a)-(j), in which the compressible truss is rotationally molded between the inner and outer components, and the compressible truss includes fixtures molded into the wall components.

Other embodiments are possible in particular instances once the full import of the description above is considered in detail. However, in all cases, the invention is not limited to any such embodiment, or to the particular exemplary embodiments specifically described above, but rather is defined by the following claims.

I claim:

1. A rotationally molded article comprising a compressible truss, in which the truss comprises two halves which move relatively toward each other to compress the truss as a whole when the article undergoes force.

2. The rotationally molded article of claim 1, in which the article has internal structure and the truss is rotationally molded into the internal structure of the article.

3. The rotationally molded article of claim 1, in which the article is rotationally molded before the truss is attached to the article.

4. The rotationally molded article of claim 1, in which the truss comprises a plurality of truss members, each truss member comprising upper and lower chords, and at least one of the upper and lower chords of a truss member further comprises one of a pin and a socket.

5. The rotationally molded article of claim 4, in which the pin is fixed to its respective chord of a truss member, and the pin slides within a socket of another truss member.

6. The rotationally molded article of claim 1, in which the truss further comprises upper and lower chords, and at least one attachment plate attached to a chord, in which each at least one attachment plate comprises features creating an increased amount of bonding between the truss and the molded article.

7. The rotationally molded article of claim 1, in which the article is a hollow walled boat.

8. The rotationally molded article of claim 1, in which the article further comprises at least two components and at least one connecting joint connecting the two components of the article, in which each connecting joint comprises a directed V-shaped indentation with a molded apex.

9. The rotationally molded article of claim 1, in which the article comprises wall components, and the compressible truss comprises fixtures molded into the wall components.

10. A process of forming a rotationally molded article, comprising attaching to the article a compressible truss, in which the truss comprises two halves which move relatively toward each other to compress the truss as a whole when the article undergoes force.

11. The process of claim 10, in which the article has internal structure and the truss is rotationally molded into the internal structure of the article.

12. The process of claim 10, in which the article is rotationally molded before the truss is attached to the article.

13. A compressible truss for a rotationally molded article, the truss comprising two halves which move relatively toward each other to compress the truss as a whole when the article undergoes force.

14. The truss of claim 13, in which the truss comprises a plurality of truss members, each truss member comprising upper and lower chords, and at least one of the upper and lower chords of a truss member further comprises one of a pin and a socket.

15. The truss of claim 14, in which the pin is fixed to its respective chord of a truss member, and the pin slides within a socket of another truss member.

16. The truss of claim 13, in which the truss further comprises upper and lower chords, and at least one attachment plate attached to a chord, in which each at least one attachment plate comprises features for creating an increased amount of bonding between the truss and the rotationally molded article.

17. The truss of claim 13, in which the article is a hollow walled boat.

18. The truss of claim 13, in which the article further comprises at least two components and at least one connecting joint connecting the two components of the article, in which each connecting joint comprises a directed V-shaped indentation with a molded apex.

19. The truss of claim 13, in which the article comprises wall components, and the compressible truss comprises fixtures molded into the wall components.
